(19) United States
(12) Patent Application Publication
(10) Pub. No.: US 2006/0049185 A1
(43) Pub. Date: Mar. 9, 2006

(54) Conveyor belt configurations for microwave oven

(76) Inventors: Randall S. Masson, Merrimack, NH (US); E. Eugene Eves II, Westford, MA (US); Bruce Secovich, Hudson, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/209,894

(22) Filed: Aug. 23, 2005

Related U.S. Application Data
(60) Provisional application No. 60/603,774, filed on Aug. 23, 2004.

(51) Int. Cl. H05B 6/78

(52) U.S. Cl. 219/700

(57) ABSTRACT

A continuous system for heating articles that pass through an oven cavity heated by microwave energy. A conveyor used to continuously feed items through the oven cavity contains one or more dividing mechanisms arranged along its longitudinal axis. The dividing mechanism(s) prevent at least some of the articles from touching one another while being heated. The dividing mechanism may take the form of one or more o-ring cord dividers that are wrapped around and driven by the conveyor. In an alternate embodiment, the dividing mechanism may comprise a plurality of molds defining a specific outer contour for the articles to be heated.

### RELATED APPLICATION(S)

This application claims the benefit of U.S. Provisional Application No. 60/603,774, filed Aug. 23, 2004. The entire teachings of the above application(s) are incorporated herein by reference.

### BACKGROUND OF THE INVENTION

Commercial food preparation operations typically involve cooking, drying, and/or browning of items. It is often necessary to apply these processes to large quantities of food articles in the shortest possible time, and this has led to the use of continuous feed microwave ovens of several types.

One such microwave oven makes use of an elongated, single mode microwave energy applicator. The single mode applicator is designed, from an electromagnetic standpoint, to be a waveguide that applies microwave energy in a shape that is optimized depending upon the shape of the product being cooked. For example, if the product being cooked is relatively square in cross-section, the applicator may itself be designed as an elongated, tapered rectangular cavity that is several feet long.

Such an applicator is typically left open on both ends so that food articles to be cooked can travel on a conveyor belt that travels inside the waveguide. With food portion sizes appropriate for heating using an applicator of this design, the product entrance and exit may be constructed using well known techniques to prevent microwave leakage. For example, the entrance and exit openings can be limited in size to be something less than the propagating waveguide dimension, which in turn depends upon the wavelength of the microwave energy. Thus, for microwave applicators designed for operating in the 900 Megahertz (MHz) region, as long as openings are no more than about 6 inches or so in each dimension, energy will be contained.

### SUMMARY OF THE INVENTION

It is thus known that a continuous feed system can be provided for heating articles passing through an oven cavity with a heating source, such as a microwave energy source. However, when a conveyor belt is used to continuously feed articles through the oven cavity, the belt may be unsupported in the middle of the oven, which causes the belt to dish or become concave. Such a belt configuration causes the food articles traveling through the oven to slide toward one another, causing the articles to stick or become adhered to one another during the heating process.

To solve this problem, the present invention presides one or more dividing mechanisms along a longitudinal axis of the conveyor. The dividing mechanisms keep at least some of the food articles from touching. In one embodiment, one or more O-ring cord dividers can be wrapped around and driven by the conveyor. A guiding device can be used to maintain the dividing mechanism on the belt in a desired position.

In other embodiments, a mold for use with a continuous feed system is provided to form products in which a specific outer contour of the articles is desired. The mold can include cavities having any desired geometrical shape, such as circular, square, triangular, oval, etc. A guiding device can be used to maintain the mold in a desired position with respect to the conveyor.

### BRIEF DESCRIPTION OF THE DRAWINGS

The foregoing and other objects, features and advantages of the invention will be apparent from the following more particular description of various embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a heating system in accordance with an embodiment of the invention.

FIG. 2 is a perspective view of the output side of the system of FIG. 1.

FIG. 3 is a perspective view of a heating system in accordance with another embodiment of the invention.

FIG. 4 is a side view of a heating system in accordance with a further embodiment of the invention.

FIG. 5 is an enlarged view of an output side of the system of FIG. 4.

FIG. 6 is a perspective view of the output side shown in FIG. 5.

FIG. 7 is a side view of a heating system in accordance with yet another embodiment of the invention.

FIG. 8 is an enlarged view of an output side of the system of FIG. 7.

FIG. 9 is a perspective view of the output side shown in FIG. 8.

### DETAILED DESCRIPTION OF THE INVENTION

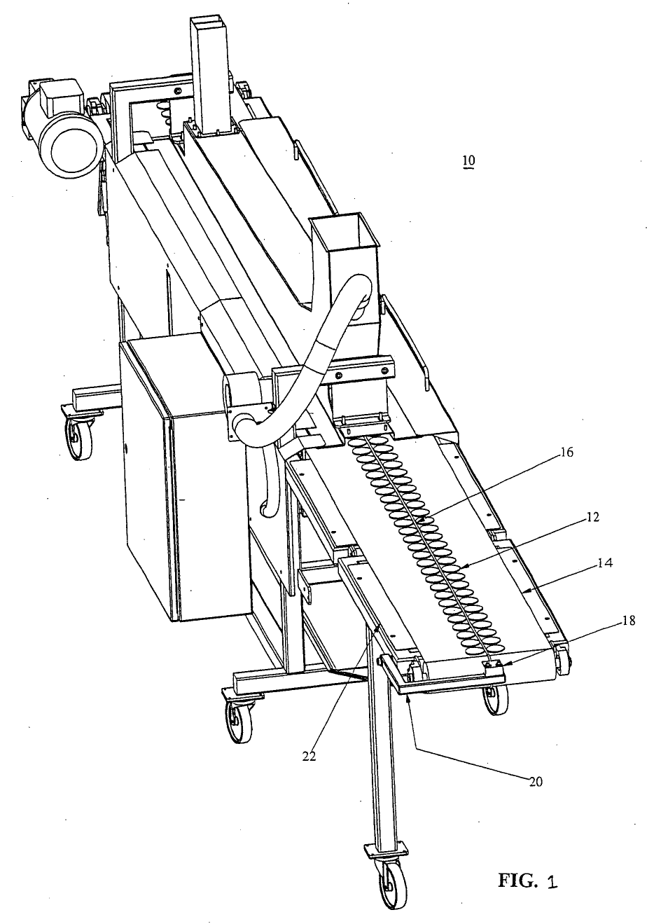

A description of preferred embodiments of the invention follows. FIG. 1 illustrates one embodiment of a partial continuous feed heating system, designated as reference numeral 10. For example, the heating system 10 can be used with the apparatus disclosed in U.S. Provisional Application No. 60/514,457, filed on Oct. 24, 2003, the entire teachings of which are incorporated herein by reference. Generally, articles 12 to be heated, cooked, browned, thawed, dried, or a combination thereof (i.e., processed), are carried by a conveyor belt 14 through at least one oven. As the articles 12 travel through the oven, they can be at least heated or cooked by one or more heating sources.

A circularly polarized microwave signal is one in which the polarization vector of the microwave energy continually rotates. Generally, however the system will use a rectangular waveguide with linear polarization.

A second heating source can include a burner or heater that provides hot air to the oven to heat the articles 12 by forced air convection. In other embodiments, the second heating source can include an infrared source or employ other suitable surface heating techniques. In further embodiments, a third heating source can be used to further process the articles 12. The third heating source can include a steam source coupled to the oven through steam vents.

Conveyor belt 14, in one embodiment, is formed from a substantially microwave transparent material. That is, the belt 14 is formed from a material that is substantially electrically non-conductive. In one embodiment, the belt is substantially heat resistant up to about 500 degrees Fahrenheit. That is, the belt can operate in temperatures sufficient to cook the articles 12 without significant degradation. In one embodiment, the belt 14 is formed from material that does not adhere to the cooked articles 12. For example, the belt 14 can be formed from glass fibers that can be woven. The glass fibers can also be mixed or coated with Teflon™ material or other suitable materials.

Because the conveyor belt 14 is unsupported in the middle of the oven, the belt tends to dish or become concave due to gravity. When this happens, it has been found that the food articles 12 traveling through the oven tend to slide toward the middle of the conveyor belt 14 and become adhered to one another as they are processed.

In one embodiment of the present invention, this problem is alleviated by one or more longitudinal dividing mechanisms 16, such as an O-ring cord divider. The dividing mechanism(s) can be used to insure that at least some of the food articles 12 do not touch each other along two or more lanes along the longitudinal axis of the conveyor belt 14.

In a particular embodiment, the dividing mechanism(s) 16 can be formed from a material that has suitable release properties, such as Teflon™ material, so that the food articles 12 do not stick to it. The dividing mechanism(s) 16 should also be formed from a material that is chemically stable, for example, FDA approved, substantially microwave transparent, substantially electrically non-conductive, and temperature resistant, for example, able to withstand temperatures of at least 300 degrees Fahrenheit without significant degradation. In a particular embodiment, the dividing mechanism 16 is formed from silicone rubber.

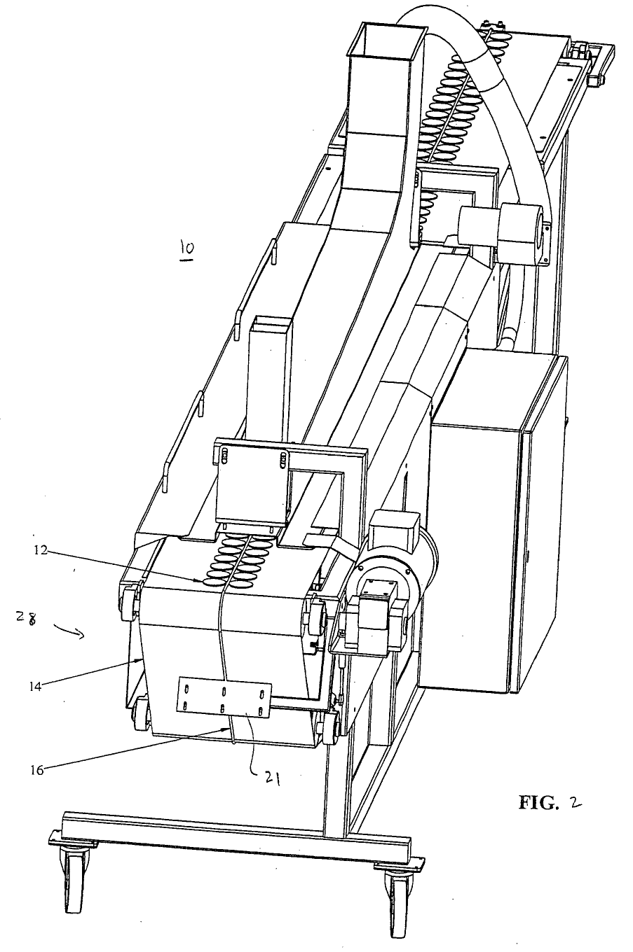

In this embodiment, the dividing mechanism(s) 16 can be wrapped around and driven by the conveyor belt 14. To keep the dividing mechanism(s) 16 in position, a guiding device that can include one or more guides 18 can be positioned on an arm 20 that is pivotable with respect to table 22. The guide 18 is movable along the arm 20 in a particular embodiment. Guide 18 includes a slot through which the dividing mechanism 16 is fed so as to maintain the dividing mechanism 16 at a desired position relative to the conveyor belt 14. A scraper 21 (FIG. 2) can be provided adjacent the output side 28 of the conveyor belt 14 to clean off the belt. The scraper 21 can include a slot through which the dividing mechanism 16 is fed to maintain the dividing mechanism 16 at a desired position relative to the conveyor belt 14.

In other embodiments, the dividing mechanism(s) 16 can be integrally formed with, or fixably attached to, the conveyor belt 14. In yet other embodiments, the dividing mechanism(s) 16 can be provided on the top surface of the conveyor belt 14, i.e., the dividing mechanism is stretched above the top surface of the conveyor belt 14. The dividing mechanism(s) 16 extends vertically from the conveyor belt 14 a distance sufficient to prevent the articles 12 being heated from touching one another.

FIG. 3 illustrates an embodiment in which one or more mold(s) 24 is provided for forming food articles 12 in which a specific outer contour of the articles is desired. In one embodiment, the mold 24 is a continuous belt of material having shaped cavities 26 formed within it. The cavities 26 can have any desired geometrical shape, such as circular, square, triangular, oval, etc. Certain food articles, for example, cheese, become thinner and wider when heated. When these food articles are placed in the cavities 26 prior to being heated, the outer contour of the food product is maintained by the cavity during the heating process.

The mold 24 can be formed from a material that has suitable release properties, such as Teflon™ material, so that the food articles 12 do not stick or adhere to it. The material should also be chemically stable, for example, FDA approved, substantially microwave transparent, substantially electrically non-conductive, and high temperature resistant, for example, able to withstand temperatures of at least 300 degrees Fahrenheit without significant degradation. The mold 24 can be a separate element than the conveyor belt 14 so as to be removable therefrom. The mold 24 can be formed from an elastomer such that it can wrap around the conveyor belt 14 and be driven thereby. In a particular embodiment, the mold 24 can be formed from silicone rubber. In other embodiments, the mold 24 can be driven separate from the conveyor belt 14. A guiding device, such as illustrated in FIG. 1, can be used to maintain the mold(s) 24 in a desired position relative to the conveyor belt 14.

In a particular embodiment, cheese is placed in the cavities 26 of the mold 24 and processed in the oven. As the water boils out of the cheese, it bubbles and puffs up and expands to form a product that is “foamy” in texture. The outer contour of the resulting product is maintained by the interior shape of the cavity 26. Without the mold 24, the cheese would melt and become thin and wide like a pancake.

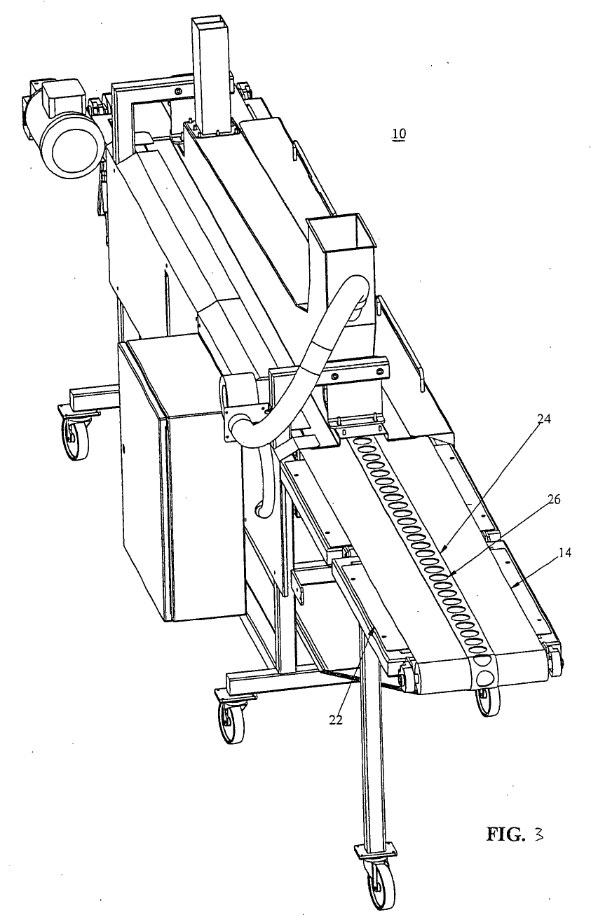

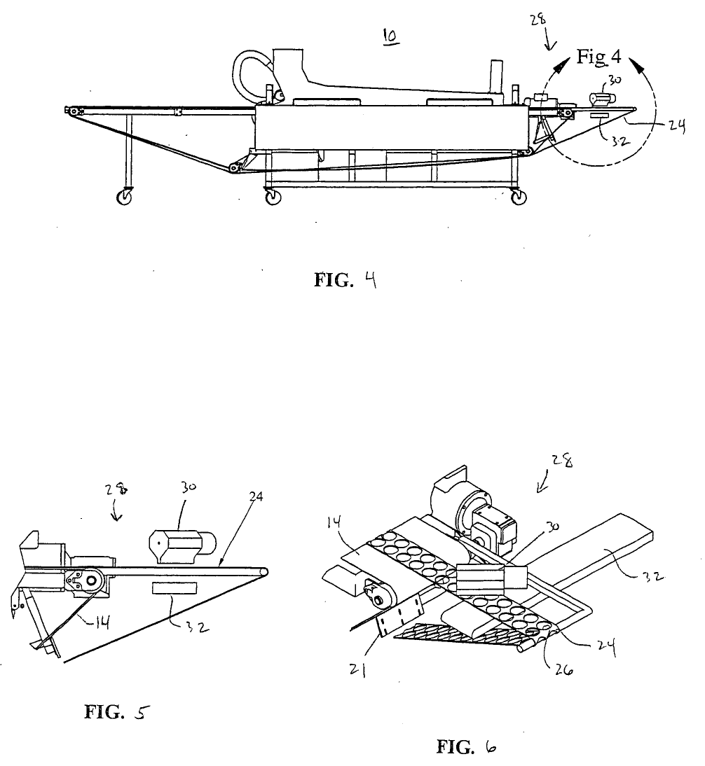

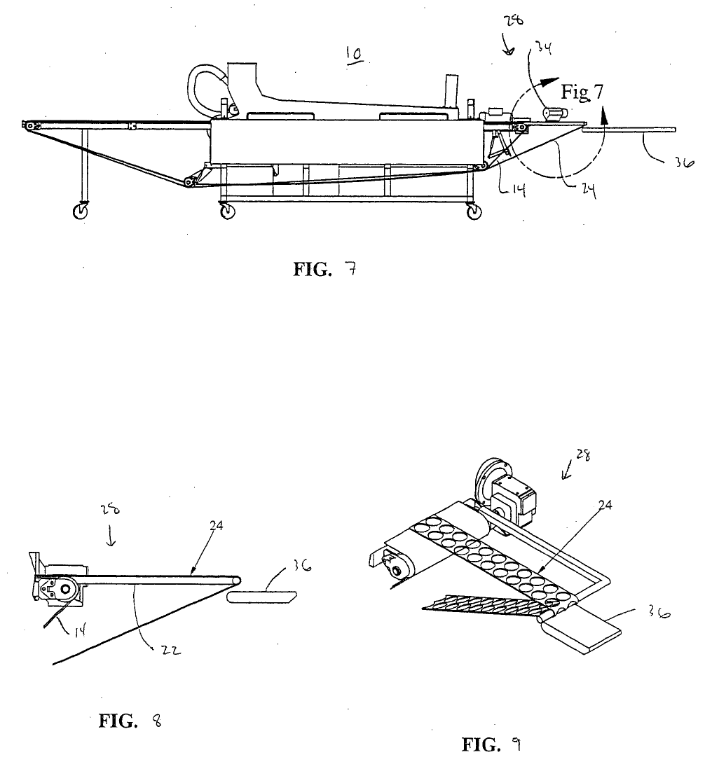

FIGS. 4-6 illustrate another embodiment of a heating system 10 in which the mold 24 extends beyond the conveyor belt 14 at the output side 28 of the system. An air knife 30 or other suitable mechanism can be used to remove the articles 12 that become adhered to the cavities 26. In this embodiment, the articles 12 can fall onto a cross conveyor belt 32 which carries the articles to a desired location.

FIGS. 7-9 illustrate a further embodiment of a heating system 10 in which the table 22 on the output side 28 of the system is extended which allows the articles 12 to cool sufficiently to become stable to increase the range of handling options. In a particular embodiment, a cooling device 34 can be used to cool the articles 12 on one or both sides of the table 22. The articles 12 can then be deposited onto another conveyor belt 36.

In further embodiments, two or more molds 24 can be provided on the conveyor belt 14 to provide two or more lanes of food product to be simultaneously processed. In other embodiments, the cavities 26 can be integrally formed in the conveyor belt 14, thereby obviating the necessity of having a separate mold having cavities therein.

While this invention has been particularly shown and described with references to preferred embodiments thereof, it will be understood by those skilled in the art that various changes in form and details may be made therein without departing from the scope of the invention encompassed by the appended claims.

What is claimed is:

1. A continuous feed heating device for articles comprising:
a heating cavity, adapted to supply heat to articles therein;
a conveyor, for continuously feeding articles to be heated into and out of the heating cavity;
a dividing mechanism, extending along a longitudinal axis of the conveyor, to prevent at least some of the articles to be heated by the heating system from touching one another.

2. An apparatus as in claim 1 wherein the dividing mechanism is formed of a material that has suitable release properties such that the articles to not adhere to it.

3. An apparatus as in claim 2 wherein the dividing mechanism material is selected from Teflon™ and silicone rubber.

4. An apparatus as in claim 1 additionally comprising:
a microwave energy source for applying microwave energy to the heating cavity.

5. An apparatus as in claim 4 wherein the dividing mechanism is formed from a microwave transparent electrically non-conductive material.

6. An apparatus as in claim 1 wherein the dividing mechanism is a strip of material wrapped around and driven by a mechanism that also drives the conveyor.

7. An apparatus as in claim 1 additionally comprising:
a guide for maintaining a position of the dividing mechanism with respect to the conveyor.

8. An apparatus as in claim 7 wherein the guide is movable along an arm that extends beyond the conveyor.

9. An apparatus as in claim 7 additionally comprising:
a scraper positioned adjacent to an output side of the conveyor, the scraper also including a slot through which the dividing mechanism is fed.

10. An apparatus as in claim 1 wherein the dividing mechanism is integrally formed with the conveyor belts.

11. An apparatus as in claim 10 wherein the dividing mechanism extends vertically from the conveyor belt at a distance sufficient to prevent articles positioned on either side of thereof from touching one another while being heated.

12. An apparatus as in claim 1 wherein the dividing mechanism is held in position adjacent to a top surface of the conveyor.

13. An apparatus as in claim 1 wherein the dividing mechanism further comprises:
one or more molds, for holding articles to be heated whereby a specific outer contour of the articles is desired to be maintained.

14. An apparatus as in claim 13 wherein the molds are formed of a continuous belt of material having shaped cavities formed within it.

15. An apparatus as in claim 14 wherein the outer contour of the articles is maintained by the shaped mold cavities during the heating process.

16. An apparatus as in claim 13 additionally comprising:
a support, extending beyond the conveyor and supporting the mold(s) at an output side thereof, such that articles can fall out of the molds onto a lower conveyor to carry other articles to a desired location.

17. An apparatus as in claim 16 additionally comprising:
an air knife to remove articles that become adhered to the mold(s).

18. A method for heating articles in an oven cavity comprising:
transporting the articles through the oven cavity on a conveyor; and
preventing, with a dividing mechanism, movement of the articles longitudinally with respect to the conveyor.

19. A method as in claim 18 comprising a step of:
controlling the outer contour of the articles as the articles are heated in the oven cavity.

20. A method as in claim 19 wherein the step of controlling the outer contour of the articles is provided by a mold having a desired shape.
